(19) United States
(12) Patent Application Publication
(10) Pub. No.: US 2018/0316543 A1
(43) Pub. Date: Nov. 1, 2018

(54) APPARATUS AND METHOD FOR MANAGING INTEGRATED PLATFORM OF WIRED AND MOBILE COMMUNICATION SERVICES

(71) Applicant: ELECTRONICS AND TELECOMMUNICATIONS RESEARCH INSTITUTE, Daejeon (KR)

(72) Inventor: Jung Yeon HWANG, Daejeon (KR)

(21) Appl. No.: 15/955,197

(22) Filed: Apr. 17, 2018

(30) Foreign Application Priority Data
Apr. 28, 2017 (KR) 10-2017-0055127

(51) Int. Cl. H04L 12/24; G06F 9/455

(52) U.S. Cl. CPC H04L 41/0206; G06F 9/45558; H04L 63/1425; G06F 2009/45562; H04L 41/22

(57) ABSTRACT

An integrated platform management apparatus to which SDN and NFV technologies are applied includes a VIM controlling and managing virtualized computing, storage, and network resources of a NFVI and interaction of the resources of the NFVI; a VNFM controlling at least one network function and virtualization of the at least one the network function so that a part of the at least one network function and the NFVI is implemented in software; and a NFV orchestrator displaying appliance functions of a plurality of VNFs in form of icons on a UI screen, and provides integrated wired, mobile, and hyper-connection communication services by connecting functions corresponding to icons selected by an OSS or a BSS among the icons displayed on the UI screen in form of a forwarding graph.

### CROSS-REFERENCE TO RELATED APPLICATION

This application claims priority to Korean Patent Application No. 10-2017-0055127, filed Apr. 28, 2017 in the Korean Intellectual Property Office (KIPO), the entire content of which is hereby incorporated by reference.

### BACKGROUND

### 1. Technical Field

The present disclosure relates to an apparatus and a method for managing an integrated platform of wired and mobile communication services, and more specifically, to an apparatus and a method for managing an integrated platform which can provide seamless communication services without boundaries between wired, mobile, and hyper-connection communication services, and perform operation managements in a unified infrastructure to which cloud computing based virtualization technologies and software defined networking (SDN) and network function virtualization (NFV) technologies are applied.

### 2. Description of Related Art

Recently, a domain of communication technologies has been promoting standardization and technology development for software defined networking (SDN) and network function virtualization (NFV) technologies.

However, current telecommunication service providers provide inefficient services in such a manner that redundant investment in infrastructure and high operation cost are required in order to separately provide infrastructures to provide wired and mobile communication services. Therefore, it is required to develop functions, structures and methods for an integrated platform without redundant investment for each separate infrastructure in order to provide wired and mobile communication services.

### SUMMARY

Accordingly, embodiments of the present disclosure provide an apparatus and a method for managing an integrated platform which provides seamless communication services without boundaries between wired, mobile, and hyper-connection communication services in a unified infrastructure to which SDN and NFV technologies are applied.

Accordingly, embodiments of the present disclosure also provide an apparatus and a method for managing an integrated platform which operates and manages wired and mobile communication services by integrating separate infrastructures prepared for the respective communication services without redundant investment.

In order to achieve the objective of the present disclosure, an integrated platform management apparatus to which SDN technologies and NFV technologies are applied may comprise a virtualized infrastructure manager (VIM) controlling and managing virtualized computing, storage, and network resources of a network function virtualization infrastructure (NFVI) and interaction of the resources of the NFVI; a virtualized network function manager (VNFM) controlling at least one network function and virtualization of the at least one the network function so that a part of the at least one network function and the NFVI is implemented in software; and a NFV orchestrator displaying appliance functions of a plurality of virtualized network functions (VNFs) in form of icons on a user interface (UI) screen, and provide integrated wired, mobile, and hyper-connection communication services by connecting functions corresponding to icons selected by an operation support system (OSS) or a business support system (BSS) among the icons displayed on the UI screen in form of a forwarding graph.

The NFV orchestrator may integrally provide the wired, mobile, and hyper-connection communication services in a unified infrastructure according to a service level agreement (SLA) and a policy based on service requirements of a service subscriber.

The NFV orchestrator may provide a physical hardware infrastructure function, a virtual machine (VM) function, a virtual network function, a networking protocol function, a virtualized infrastructure function, a wired service module, a mobile service module, a service catalogue module, a big-data analysis platform, and a VNF service automatic test tool in form of icons.

The VM function may include a master VM template software image function for configuring VMs or virtual containers (VCs) according to a hypervisor or a docker for automatic initial configuration services in physical hardware resources, and perform the automatic initial configuration to create VM instances.

The virtual network function may divide a physical network apparatus into a plurality of network functions (NFs) to perform virtualization of the physical network apparatus.

The virtualized infrastructure function may create VMs or VCs according to a hypervisor or a docker so as to allow use of virtualized resources.

The wired service module may apply VNFs to VMs or VCs for a wired communication service, and provide the wired communication service by configuring a forwarding graph in a drag-and-drop manner with service functions represented as icons through at least one virtualized appliance and at least one virtualized tunneling gateway.

The mobile service module may apply VNFs to VMs or VCs for a mobile communication service, and provide the mobile communication service by configuring a forwarding graph in a drag-and-drop manner for service functions represented as icons through at least one virtualized appliance.

The service catalogue module may guarantee resources for a network slice according to a type of a mobile communication service.

The big-data analysis platform may perform a structured big-data analysis or an unstructured big-data analysis based on data collected from Internet-of-Things (IoT) devices of the hyper-connection communication service.

The VNF service automatic test tool may perform a VIM function test, a VNF creation/modification/expansion/reduction/removal function test, a VNF network connection test, an interworking test between VIM and SDN controller, a SDN controller test, and a NFVI function test to ensure that the NFVI meets VIM requirements.

The NFV orchestrator may provide a subscriber and policy management function, a service catalogue and traffic control management function, a VNFM management function, a VIM management function, a SDN integrated control management function, a micro internet data center (IDC) interoperation management function, a security management function, a billing management function, and a statistics management function in form of a pull-down menu on the UI screen.

The service catalogue and traffic control management function may retrieve information on a service usage status for each subscriber type, each supplementary service type, each day, or each month, and perform a VNF-specific service chaining monitoring, an infrastructure traffic monitoring for VIMS, an infrastructure resource management, a performance management, a service catalogue management, or a service slicing management.

The VNFM management function may perform a VNF instance lifecycle management, a snivel instance management, a multiple instance management, a VNF instance configuration management, an update or upgrade of VNF instance software, a change of VNF instance, a VNF instance performance information management, a failure information and event management, a VNF instance provisioning and automatic recovery, or addition and deletion of VNF instance.

The VIM management function may perform a hardware resource management of entire infrastructure, a virtualization management of virtual infrastructures to which a hypervisor or a docker is applied, an infrastructure resource allocation, management of deallocating, increasing and decreasing allocated resources, or infrastructure operation management.

The SDN integrated control management function may perform control of an Open vSwitch or an OpenFlow switch according to a network data plan, a network equipment setup, a state collection management, an equipment connection management and integrated control management, a Southbound networking, a Northbound application programming interface (API) networking, a micro IDC networking, an NFV orchestration networking, a service catalogue networking, a networking failure information collection, a failure information propagation and failover, a provisioning, a service function chaining (SFC), or interworking with a network management system (NMS).

The micro IDC interoperation management function may perform monitoring of equipments applied at edge stages, analysis of information collected at subscriber terminals, storing of data collected from IoT devices, or status management, failure management, recovery function, and security management of micro equipments.

The security management function may perform monitoring of traffic received by a micro IDC, protocol anomaly detection and monitoring, virus detection, webblocker, remote security connections, or storing of traffic information, and performs analysis of traffic big-data, modified packet blocking, time-based policy setting, allowance or denial of instant messaging and point-to-point (P2P) data transfer, storing of billing information for each service type or each subscriber, storing of log information of multiple equipment, or logging and report of simple network management protocol (SNMP) v2/v3 data.

The billing management function may perform real time charge data record (CDR) generation and billing processing function, billing processing control function by billing rate, billing history inquiry, billing history management, billing history file creation function, billing by service layer, or billing functions for each service type or each subscriber.

The statistics management function may perform functions of providing information of statistics on subscriber types, statistics per service type, daily/monthly traffic statistics, statistics on virtualized computing server/storage/network resource information, statistics on physical hardware resource information, micro IDC physical hardware resource statistics, micro IDC virtual resource statistics, billing statistics, or failure statistics.

Using the integrated platform management apparatus and method for wired and mobile communication services according to an embodiment of the present disclosure, a vCPE service based on a VNF forwarding graph can be provided. Through the UI screen provided by the NFV orchestrator 110, the operator of the service provider can drag and drop icons of a desired service among the modules I200 to I290 according to a communication service request, connect the selected icons of the desired service in the form of the VNF forwarding graph, and immediately provide the desired service according to the communication service request to the subscriber. As a result, each subscriber can be provided services by applying necessary appliances to the VNFs in the ISP's cloud infrastructure. Therefore, the subscriber does not need a separate computer room, and there is no need to arrange the equipment separately for the Internet security.

The integrated platform management apparatus and method can provide a future communication service that does not distinguish between wired, mobile, and hyper-connection communication services with a single infrastructure based on cloud computing based virtualization technologies and SDN/NFV technologies. Therefore, the investment cost (i.e., capital expenditure (CAPEX)) for redundant investment in infrastructure (computer, storage, and network) can be reduced. In addition, the operation of the unified single infrastructure can reduce the operation cost (i.e., operating expenses (OPEX)) for redundant infrastructure operations.

The integrated platform management apparatus and method can provide both wired and wireless communication services. Through this, subscriber (e.g., corporate, home, personal) management, traffic monitoring management by type and grade of service, physical hardware system failure management, security management, and integrated billing management can all be performed on the single integrated platform. Therefore, it is made possible to reduce the CAPEX by the integrated operation of the equipment and reduce the carbon emission by the power reduction by applying the virtualized integrated infrastructure. Also, the virtualization technologies can reduce the use of equipment to be applied to data centers, which can reduce the CAPEX and OPEX.

The integrated platform management apparatus and method can enable a forwarding graph to be configured by using icons of application services having appliance mounted on a system in which an infrastructure (computer, storage, and network) is virtualized on a UI screen. This makes it possible to quickly and easily provide tasks such as communication service creation and change according to a business model of the service provider.

### BRIEF DESCRIPTION OF DRAWINGS

Embodiments of the present disclosure will become more apparent by describing in detail embodiments of the present disclosure with reference to the accompanying drawings, in which:

FIG. 1 is a diagram illustrating an ETSI NFV architectural framework;

FIG. 2 is a diagram illustrating a user interface screen for configuring wired, mobile, and hyper-connection communication services as a function of orchestrator in the integrated platform according to an embodiment of the present disclosure;

FIG. 3 is a diagram illustrating a method of providing a VNF service by a service catalogue;

FIG. 4 is a diagram illustrating an example of providing wired, mobile, and hyper-connection communication services; and

FIG. 5 is a diagram illustrating an example of a vCPE service configured according to a VNF forwarding graph (service chaining).

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate a thorough understanding of the present disclosure, the same reference numerals are used for the same constituent elements in the drawings and redundant explanations for the same constituent elements are omitted.

The present disclosure proposes an apparatus and a method of managing an integrated platform for wired and mobile communication services, which can support operational managements in a unified infrastructure utilizing SDN and NFV technologies based on virtualization (e.g., virtual machine (VM) or virtual container (VC)) of cloud computing. Also, the present disclosure proposes an apparatus and a method of managing an integrated platform for wired and mobile communication services, which can perform service traffic monitoring, failure management of physical hardware systems (computer, storage, and network), security management, virtual infrastructure (computer, storage, and network) management, and subscriber management.

The apparatus and method of managing an integrated platform for wired and mobile communication services according to the present disclosure may apply virtualized network functions (VNF) to VM or VC which virtualizes an infrastructure (computer, storage, and server), and implement various appliances and application software (e.g. vCPE, vFW, vCPI, vIPS, vRGW, vSTB, vCDN, vEPC, vIMS, vRAN, vHSS, vAAA, vIoT (Internet of Things) platform, and vBigdata platform, etc.). Also, since a plurality of application software are applied as appliances to the multiple VNFs according to a service catalogue classified to provide wired, mobile, and hyper-connection communication services using the integrated platform of the present disclosure, icons for the wired, mobile, and hyper-connection communication services to be provided can be dragged and dropped from the service catalogue, and the desired communication services can be provided easily and efficiently using a forwarding graph configured with the icons.

Also, the apparatus and method of managing an integrated platform for wired and mobile communication services may apply respective application software and appliances to VMs or VCs according to a hypervisor or a docker to the computers of the infrastructure. Thus, executable files can be dragged and dropped in forms of icons from an operator's integrated platform, and thus the requested wired, mobile, and hyper connection communication services can be provided easily and quickly by configuring a forwarding graph of VNFs according to the service catalogue.

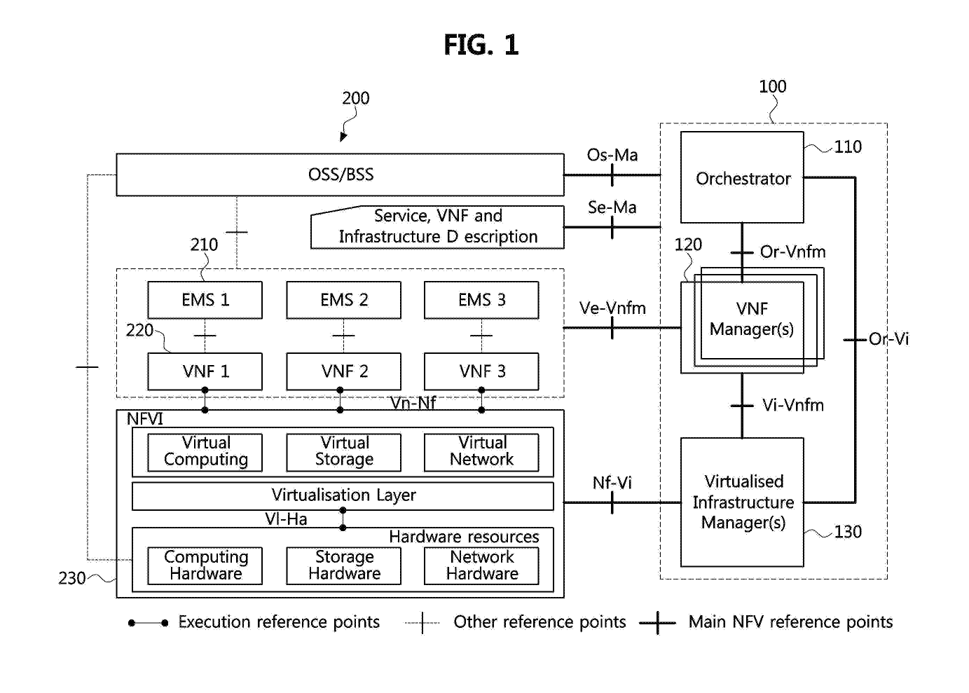

FIG. 1 is a diagram illustrating an ETSI NFV architectural framework.

Referring to FIG. 1, the European Telecommunications Standard Institute (ETSI) Group Specification (GS) NFV architectural framework may include an integrated platform management apparatus 100 for wired and mobile communication services and a service support system 200 according to an embodiment of the present disclosure.

The integrated platform management apparatus 100 may comprise a NFV orchestrator 110, a Virtualized Network Function Manager (VNFM) 120, and a Virtualized Infrastructure Manager (VIM) 130. Also, the service support system 200 may comprise an Operations Support System (OSS), a Business Support System (BSS), a plurality of Element Management Systems (EMSs) 210, a plurality of Virtual Network Functions (VNFs) 220, and a Network Function Virtualization Infrastructure (NFVI) 230.

The NFV orchestrator 110 may perform coordination and management of NFV infrastructure and software resources. Also, the NFV orchestrator 110 may control the VIM 130 and the NFVI 230 such that network services (NSs) are implemented in the NFVI 230. In addition, the NFV orchestrator 110 may manage mounting of new NSs and VNF packages. The NFV orchestrator 110 may also manage life cycles (e.g. instantiation, scaling up or down, performance measurement, event correlation analysis, termination, or the like) of the NSs. The NFV Orchestrator 110 may also manage, verify, and authorize resource requests of the NFVI 230, and integrate the NFV into the existing network by interacting with the OSS/BSS environments.

The VNFM 120 may control Network Functions (NFs) and the NFV so that all or a part of the NFs and the NFVI can interwork with a plurality of VNFs 220 as implemented in software. The VNFM 120 may manage virtual components, and manage the life cycles of the VNFs 220. For example, the VNFM 120 may manage instance creation, update query, and termination of each of the plurality of VNFs 220. Also, the VNFM 120 may manage configuration and event reporting between the NFVI 230 and the EMS and a Network Management System (NMS).

The VIM 130 may control and manage resources, interaction of computing, storage, and network resources of the NFVI 230. The VIM 130 may also control and manage the computing, storage, and network resources of the NFVI 230 within a sub-domain of an infrastructure of a service provider. The VIM 130 may also control performance measurement, and event collection and delivery of the NFVI 230.

Specifically, the VIM 130 may manage software (e.g. a hypervisor), computing, and network resources of the NFVI 230 in terms of resource management. The VIM 130 may also allocate virtual enablers, convert VMs through the hypervisor, and manage resources, storage, and network connections. Also, the VIM 130 may manage infrastructure resources and allocations. For example, the VIM 130 may increase resources for the VM and improve energy efficiency and regeneration of resources. The VIM 130 may also analyze reasons of performance problems from the NFVI perspective, collect infrastructure failure information, and collect information for capacity planning, monitoring, and optimization.

The plurality of EMSs 210 of the service support system 200 may perform functions of failure, configuration, accounting, performance, and security for each of the VNFs 220.

The VNFs 220 of the service support system 200 may be software of NFs executed through the NFVI 230. The VNFs 220 may be implemented as network nodes each of which does not depend on specific hardware, and may correspond to each physical network function (e.g. an Evolved Packet Core (EPC) such as MME, SGW, PGW, or the like). The VNFs 220 may be implemented as a set of NFs as software for supporting various application programs.

The NFVI 230 of the service support system 200 may provide virtual resources needed to support execution of the VNFs 220. The NFVI 230 may be comprised of hardware resources, virtualized resources, and virtualization functions to support computing, storage, and networking between the VNFs 220, and include software that virtualizes commercial off the shelf (COTS) hardware, components of accelerator, and base hardware.

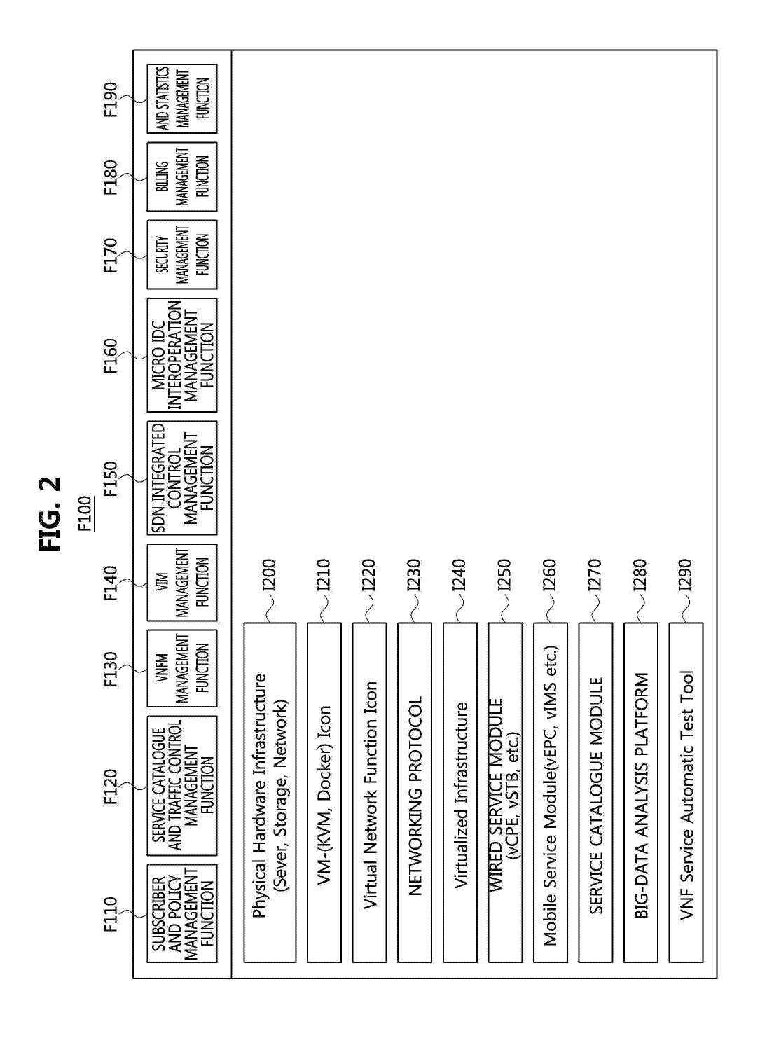

FIG. 2 is a diagram illustrating a user interface screen for providing wired, mobile, and hyper-connection communication services as a function of orchestrator in the integrated platform according to an embodiment of the present disclosure.

Referring to FIG. 2, a user interface (UI) screen for realizing the integrated platform functions of the orchestrator is illustrated. That is, FIG. 2 illustrates an initial screen (F100) displayed when the operator logs in to the integrated platform by inputting a user identity (ID) and a password.

The NFV orchestrator 110 of the integrated platform management apparatus 100 may perform a subscriber and policy management function F110, a service catalogue and traffic control management function F120, a VNFM management function F130, a VIM management function F140, a SDN integrated control management function F150, a micro (edge) IDC interoperation management function F160, a security management function F170, a billing management function F180, and a statistics management function 190. Also, in order to allow the operator to conveniently combine and control the functions, the functions are displayed in a pull-down menu form on the UI screen shown in FIG. 2 so that one or more of them can be selected from the pull-down menu.

Here, the above-mentioned functions F110 to F190 are provided in the form of the pull-down menu. Also, in order to make the operation management convenient, the functions may be categorized according to functions needed for various operation managements. Also, a command-line interface (CLI) screen may be provided together with the pull-down menu. This may allow the operator to conveniently configure the communication services which the operator desires to select and apply.

The NFV orchestrator 110 may be configured with servers of VNFs having the functions in separate VMs or VCs, for the subscriber and policy management function F110, the service catalogue and traffic control management function F120, the VNFM management function F130, the VIM management function F140, the SDN integrated control management function F150, the micro IDC interoperation management function F160, the security management function F170, the billing management function F180, and the statistics management function 190. Thus, the menus of the respective functions F110 to F190 may be linked to the respective VNF servers.

The subscriber and policy management function F110 may be connected to a server managing subscriber profiles, and may include functions of registering, retrieving, and correcting information such as subscriber (corporate, home, personal, etc.) history information and service type (supplementary service type for each subscriber type), and the like.

The service catalogue and traffic control management function F120 may allow the operator to retrieve information on service usage status, such as information on service usage status for each subscriber type, each supplementary service type, each day, each month, or the like. Also, it may include functions for VNF-specific service chaining monitoring and infrastructure traffic monitoring for VIMS. In addition, it may include functions such as system and service monitoring, infrastructure resource (capacity, usage amount, etc.) management, performance management, service catalogue management, or service slicing management.

The VNFM management function F130 may perform management of VNF instance lifecycle (creation, scaling, start and termination, information), management of a single instance, management of multiple instances, management of VNF instance configuration, update or upgrade of VNF instance software, change of VNF instance, management of performance information of VNF instance, failure information and event management, VNF instance provisioning and automatic recovery, addition and deletion of VNF instance, configuration management and event reporting between VIM and EM, or interworking with the orchestrator 110.

The VIM management function F140 may perform resource management of CPU, memory, and disk space which are physical hardware resources of the entire infrastructure (e.g. computing server, storage, network, etc.), virtualization management of virtual infrastructure (computing, storage, network) to which a hypervisor (e.g. KVM) or a docker is applied, infrastructure resource allocation, infrastructure resource deallocation, management of increasing and decreasing allocated resource, mobility management, or infrastructure operation management. Also, as the infrastructure operation management functions, the function F140 may perform management of information such as infrastructure failure, operational status, planning, monitoring, and performance, and multi-tenant resource management.

The SDN integrated control management function F150 may perform control of Open vSwitch (OVS) or OpenFlow switch according to a network data plan, network equipment setup, state collection management, equipment connection management and integrated control management, Southbound networking, Northbound API networking, micro (edge) IDC networking, NFV orchestration networking, service catalogue networking, networking failure information collection, failure information propagation and failover, provisioning, service function chaining (SFC), or interworking with the NMS.

The micro (edge) IDC interoperation management function F160 may control network apparatuses through a SDN controller. Also, the micro (edge) IDC interoperation management function F160 function may perform monitoring on the equipments applied at the edge stage (e.g. vCDN, vCPE, vSTB, vRAN, vEPC, vIMS, etc.), analysis of information data collected at subscriber terminals, transfer of information collected from IoT devices to a macro IDC information storage devices, or status management, failure management, recovery function, and security management of micro equipments.

The security management function F170 may perform monitoring of traffic received by the micro IDC (stateful packet firewall, application firewall, spyware protection, DoS or DDoS attack protection), protocol anomaly detection and monitoring, virus detection, webblocker, remote security connections (e.g. L2TP/IPSec, SSL VPN, PPTP, OpenVPN, etc.), or storing of traffic information. Also, the security management function F170 may perform analysis of traffic big-data (behavior based analysis, pattern matching, etc.), modified packet blocking, time-based policy setting, allowance or denial of instant messaging and point-to-point (P2P) data transfer, storing of billing information for each service type or each subscriber, storing of log information of multiple equipment, logging and report of simple network management protocol (SNMP) v2/v3 data, or the like.

The billing management function F180 may perform real time charge data record (CDR) generation and billing processing function, billing processing control function by billing rate, billing history inquiry, billing history management, billing history file creation function, billing by service layer, billing functions for each service type or each subscriber, or the like.

The statistics management function F190 may perform functions of providing information of statistics on subscriber types, statistics per service type, daily/monthly traffic statistics, statistics on virtualized computing server/storage/network resource information, statistics on physical hardware resource information, micro (edge) IDC physical hardware resource statistics, micro (edge) IDC virtual resource statistics, billing statistics, failure statistics, or the like. The function F190 may provide graphical representation of each statistical information, and reports using the statistical information.

Then, the integrated platform management apparatus 100 may provide a physical hardware infrastructure function I200, VM function I210, a virtual network function I220, a networking protocol function I230, a virtualized infrastructure function I240, a wired service module I250, a mobile service module I260, a service catalogue (slicing) module I270, a big-data analysis platform I280, and a VNF service automatic test tool I290.

The physical hardware infrastructure function I200 may provide status information on the physical hardware infrastructure (computing, storage, and network) resources of the macro IDC or micro (edge) IDC.

The VM function I210 may include a master VM template software image function for configuring VM or VC according to a hypervisor or a docker for automatic initial configuration services of VM or VC in the physical hardware resources, and perform the automatic initial configuration function to create VM instances. Through this, it may perform a function of configuring multiple instances, and perform a function of generating an agent generated as VM or VC.

The virtual, network function I220 may divide physical network apparatus into a plurality of NFs to perform virtualization of the physical network apparatus. Each NF may perform a network function that is typically implemented by the physical network apparatus and one or more NFs may be hosted in VM or VC in order to handle network scalability, expansion, and migration associated with the physical network apparatus. The virtual network function I220 may perform an initialization process for on-boarding the VNF package to perform VNF instantiation, and a process of registering the VNF descriptor (VNFD) in the catalogue and uploading the software image to the repository. Here, the image repository may be applied as allocated in the VIM. Here, the virtual network function I220 may perform grouping of VCs together using a group identifier (ID) corresponding to a network node virtualized with a plurality of NF units. Also, the virtual network function I220 may perform grouping of VCs using the group ID, monitor resource usage for each of L2/L3 VPN services and the VCs, and control resource allocation.

The networking protocol function I230 may include IP, ICMP, IGMP, ARP, RARP, SNMP, DHCP, and routing protocols (RIP, OSPF, BGP, etc.), and perform software functions of a network operating system in which the IP, ICMP, IGMP, ARP, RARP, SNMP, DHCP, routing protocols, and the routing protocol are used. In addition, the networking protocol function I230 may perform a function of installing network operating system software on bare metal or white-box equipment.

The virtualized infrastructure function I240 may create VMs or VCs according to a hypervisor (e.g. KVM) or a docker by acquiring the physical hardware resources (computing, storage, and network) of the infrastructure in advance so as to allow usage of the virtualized resources. This may allow the operator to use the VM (or VC) in a drag-and-drop manner on the operator UI screen.

The wired service module I250 may apply VNFs to VMs or VCs for the wired communication service, virtualize at least one appliance (e.g., vCPE, vSTB, vRGW, vCDN, vIDS, vIPS, vUTM, vFW, vSSO, etc.), and at least one tunneling gateway (e.g. IPSec/SSL VPN, GRE, GTP, etc.) which are applied to the wired communication service, and provide the wired communication service by configuring a forwarding graph in a drag-and-drop manner with service functions (e.g., NFVlaaS, VNFaaS, VNF FG, and VNFPaaS, etc.) represented as icons.

The mobile service module I260 may apply VNFs to VMs or VCs for the mobile communication service. Then, the mobile service module I260 may provide the mobile communication service by configuring a forwarding graph in a drag-and-drop manner with services functions (e.g., NFVlaaS, VNFaaS, VNF FG, and VNFPaaS, etc.) represented as icons through at least one virtualized appliance (e.g., vEPC, vIMS, vRAN, vCDN, etc.).

The service catalogue (slicing) module I270 may configure a VNF forwarding graph for each service type in advance for wired and mobile communication services, and guarantee resources of each network slice (virtualized server resources, virtualized network resources). At this time, a specific dedicated network may be provided for each of a variety of services having different characteristics in a form of providing a service so that slices are isolated from each other and error or failure of a specific slice does not affect communications of other slices.

The big-data analysis platform I280 may be a platform for performing big-data analysis based on data collected from the IoT devices of the hyper-connection communication service. The big-data analysis platform I280 may apply algorithms for pre-analysis to VNFs in order to analyze structured big-data and unstructured big-data, respectively.

The VNF service automatic test tool I290 may perform a basic VIM function test including VNF image operation, a VNF creation/modification/expansion/reduction/removal function test, a VNF network connection test, an interworking test between VIM and SDN controller, a SDN controller test, and a NFVI function test to ensure that the NFVI meets VIM requirements.

As described above, the NFV orchestrator 110 may provide the subscriber and policy management function F110, the service catalogue and traffic control management function F120, the VNFM management function F130, the VIM management function F140, the SDN integrated control management function F150, the micro IDC interoperation management function F160, the security management function F170, the billing management function F180, and the statistics management function 190 in the form of the pull-down menu, so that the operator can apply one or more functions to a communication service to be provided by selecting the one or more functions from the pull-down menu.

Also, the NFV orchestrator 110 may provide the physical hardware infrastructure function I200, the VM function I210, the virtual network function I220, the networking protocol function I230, the virtualized infrastructure function I240, the wired service module I250, the mobile service module I260, the service catalogue module I270, the big-data analysis platform I280, and the VNF service automatic test tool I290 in the form of icons, so that operator can apply one or more functions to a communication service to be provided by selecting the one or more functions in the drag-and-drop manner.

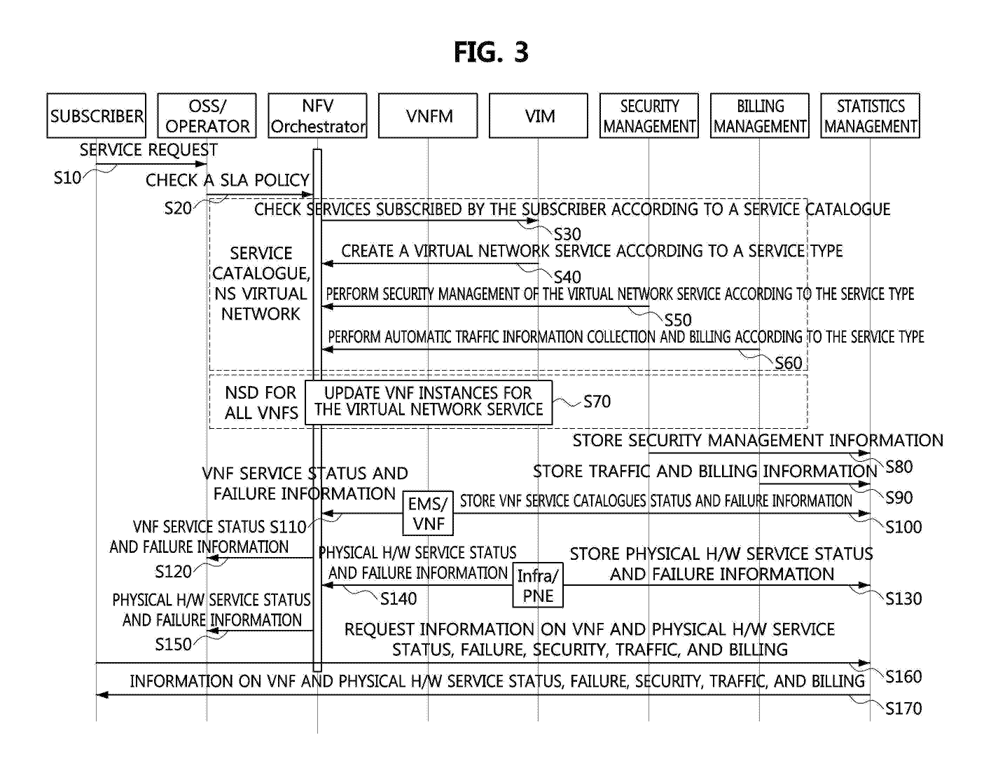

FIG. 3 is a diagram illustrating a method of providing a VNF service by a service catalogue.

Referring to FIG. 3, in order to receive a communication service, a subscriber may request the communication service to the integrated platform management apparatus 100 (S10).

Then, the OSS (or, BSS) operator may request a service level agreement (SLA) policy for the service request of the subscriber to the NFV orchestrator 110, and check whether the service according to the service request can be provided based on the SLA for the subscriber (S20).

Then, in cooperation with the VIM 130, the NFV orchestrator 110 may check services subscribed by the subscriber based on the service catalogue, and identify information related to performance of instances after creating and providing the requested new service (S30).

Then, the NFV orchestrator 110 may check the network service (NS) information, and request the VIM 13 for performance related information of the network service (NS) virtual network, resources. Thereafter, the NFV orchestrator 110 may perform creation, modification, or deletion of the virtual network service according to the requested service type by checking the performance related information, of the network service (NS) virtual network resource received from the VIM 130 (S40).

Then, the NFV orchestrator 110 may request automatic security management for the virtual network service according to the service type and the subscriber policy, in cooperation with the security management function F170 (S50).

Then, the NFV orchestrator 110 may perform automatic traffic information collection and billing for each subscriber service type in conjunction with the billing management function F180 (S60).

Then, the NFV orchestrator 110 may perform update of VNF instances for the virtual network service according to the service catalogue for the plurality of VNFs (S70).

Then, the NFV orchestrator 110 may store security management information according to the service provisioning, which was generated by the security management function F170, through the statistics management function F190 (S80).

Then, the NFV orchestrator 110 may store the traffic information and the billing information according to the service provisioning, which were generated in the billing management function F180, through the statistics management function F190 (S90).

Then, the plurality of EMSs 210 and the plurality of VNFs 220 may collect and store the VNF service catalogue status, state management and failure management information for each VNF through the statistics management function F190, and provide them to the VNFM 120 (S100). Also, together with the step S100, the VNFM 120 may request the VNF status and failure information of the NFV orchestrator 110 (S110).

The NFV orchestrator 110 may then provide the OSS/BSS with the VNF service status and failure information requested from the OSS/BSS operator. At this time, the VNF service status and failure information may be displayed on the UI screen (S120).

The NFV orchestrator 110 may then transfer the OSS (or, BSS) operator's infrastructure information request to the VIM 130. The VIM 130 may store the status of the hardware (HW) physical service and failure information for the infrastructure information request through the statistical management function F190 (S130).

Together with the step S130, the VIM 130 may collect and store the hardware physical service status and failure information of the infrastructure, and then provide the hardware physical service status and failure information and of the infrastructure to the NFV orchestrator 110 (S140).

Then, the NFV orchestrator 110 may display hardware information of the infrastructure such as service status, failures, and statistics through the UI screen. That is, the NFV orchestrator 110 may provide the hardware information to the OSS operator through the UI screen (S150).

Then, the OSS operator may request statistics management information including all information about the VNFM 120 and the VIM 130 through the NFV orchestrator 110 (S160). Here, the NFV orchestrator 110 may receive the statistics management information about the VNFM 120 and the VIM 130 through the statistical management function F190. The NFV orchestrator 110 may then provide the statistics management information about the VNFM 120 and the VIM 130 to the OSS (S170). Here, the NFV orchestrator 110 may display the statistics management information about the VNFM 120 and the VIM 130 on the UI screen.

The OSS operator may select a menu item corresponding to each statistical management type displayed on the UI screen of the NFV orchestrator 110. When the menu item corresponding to each statistical management type is selected, the selected contents are extracted and displayed graphically on the screen.

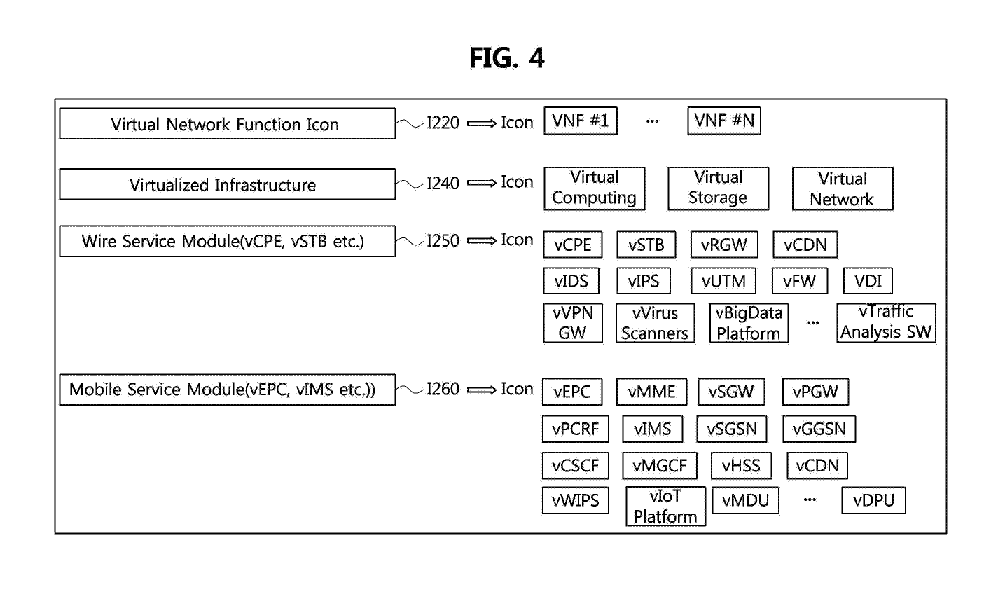

The integrated platform management method for wired and mobile communication services may comprise a step of arranging icons of a plurality of functions for providing wired, mobile, and hyper-connection communication services, a step of displaying the icons for the plurality of functions on the UI screen, and a step of integrating the wired, mobile, and hyper-connection services in a unified infrastructure by connecting icons for a plurality of functions selected in the OSS or BSS in form of the forwarding graph. Hereinafter, an example of a specific method of integrally providing wired, mobile, and hyper-connection services in a unified infrastructure will be described with reference to FIG. 4.

FIG. 4 is a diagram illustrating an example of providing wired, mobile, and hyper-connection communication services.

Referring to FIG. 4, the virtualized infrastructure function I240 may secure physical hardware resources for the infrastructure (computing, storage, and network), and create a VM according to hypervisor (KVM) or a VC according to a docker in order to allow use of virtual resources (computing, storage, network) based on the secured physical hardware resources. Through this, the VM or the VC can be used in the drag-and-drop manner from the operator UI screen.

The NFV orchestrator 110 may display the virtual network function I220 in form of icons on the UI screen, and the OSS/BSS operator may select a desired service or function from the virtual network function I220 displayed as the icons in the UI screen and activate the selected service or function. In FIG. 4, a plurality of VNFs are selected and activated among the virtual network function I220 as an example.

The virtual network function I220 may be a module for configuring the VNFs 220 by selecting the icon of VMs or VCs of the virtualized infrastructure I240 in the drag-and-drop manner so as to allocate CPU and memory to appliances, and install the appliances in VMs or VCs. Here, the virtual network function I220 may divide the physical network apparatus into a plurality of NFs to perform virtualization of the physical network apparatus. Each NF may perform a network function that is typically implemented by the physical network apparatus, and one or more NFs may be hosted to handle network scalability, expansion, and migration associated with the physical network apparatus in the VM or VC. Also, the virtual network function I220 may perform an initialization process for on-boarding the VNF package to perform VNF instantiation, registering of the VNFD in the catalogue, and uploading of the software image to the repository. The image repository may be applied as allocated to the VIM.

The NFV orchestrator 110 may display the virtualized infrastructure function I240 in form of icons on the UI screen, and the OSS/BSS operator may select a desired service or function among the virtualized infrastructure function I240 displayed on the UI screen through the NFV orchestrator 110 to activate the desired service or function. In FIG. 4, an example in which ‘virtual computing’, ‘virtual storage’, and ‘virtual network’ are selected and activated among the virtualized infrastructure function I240 is illustrated.

The wired service module I250 may allow the OSS/BSS operator to select one or more icons of the VNFs in the drag-and-drop manner, and install appliance software for the wired communication service such as vCPE, vSTB, vRGW, vCDN, vIDS, vIPS, vUTM, vFW, vSSO, UTM, VDI, VPN-GW, vVirus scanner, vBig-data platform, vTraffic analysis software, test software, or the like.

The NFV orchestrator 110 may display functions of the wired service module I250 on the UI screen in form of icons, and the OSS/BSS operator may select one or more desired services or functions from the functions displayed on the UI screen so as to activate the one or more selected services or functions. In FIG. 4, an example in which vCPE, vSTB, vRGW, vCDN, vIDS, vIPS, vUTM, vFW, VDI, vVPN GW, vVirus scanners, vBig-data platform, and vTraffic analysis software are selected and activated among the functions of the wired service module I250 is illustrated.

The mobile service module I260 may apply the VNFs to the VM (or, VC) in advance for the mobile communication service by the NFV. Also, the mobile service module I260 may install software appliances for the mobile communication service (e.g., EPC, MME, SGW, PGW, PCRF, IMS, SGSN, GGSN, CSCF, MGCF, HSS, AAA, CDN, WIPS, IOT Platform, MDU, and PDU) in the VM (or, VC). Here, the above-mentioned software appliances may be configured using icons.

The NFV orchestrator 110 may display functions of the mobile service module I260 on the UI screen in the form of icons, and the OSS/BSS operator may select one or more desired services or functions among the functions displayed on the UI screen to activate one or more selected services or functions. In FIG. 4, an example in which vEPC, vMME, vSGW, vPGW, vPCRF, vIMS, vSGSN, vGGSN, vCSCF, vMGCF, vHSS, vCDN, vWIPS, vIoT Platform, vMDU, and vDPU are selected and activated is illustrated.

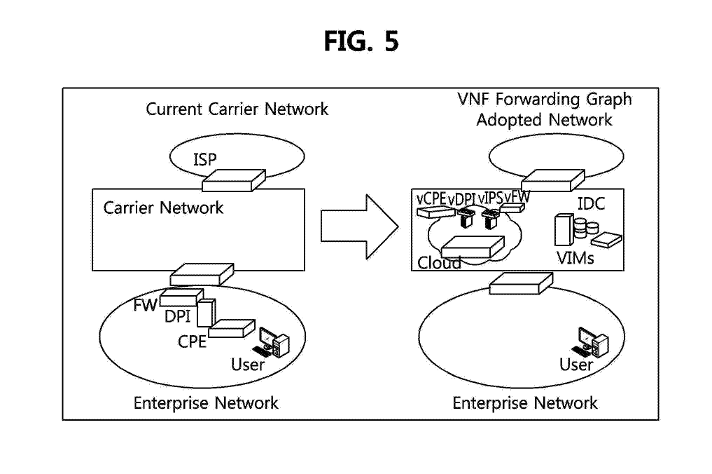

FIG. 5 is a diagram illustrating an example of a vCPE service configured according to a VNF forwarding graph (service chaining).

Referring to FIG. 5, the NFV orchestrator 110 may display the physical hardware infrastructure function I200, the VM function I210, the virtual network function I220, the networking protocol function I230, the virtualized infrastructure function I240, the wired service module I250, the mobile service module I260, the service catalogue module I270, the big-data analysis platform I280, and the VNF service automatic test tool I290 on the UI screen in the form of icons. Also, the NFV orchestrator 110 may allow the OSS/BSS operator to select one or more desired functions corresponding to a service to be provided in the drag-and-drop manner. Also, the NFV orchestrator 110 may allow the OSS/BSS operator to connect the selected icons of VNFs in a forwarding graph form, and provide the communication service desired by the subscriber according to the forwarding graph.

Specifically, as illustrated in FIG. 5, according to the conventional technology, a CPE, a firewall, and a DPI are installed in the enterprise network, and they are connected to external environments through ISP.

On the other hand, using the integrated platform management apparatus and method for wired and mobile communication services according to an embodiment of the present disclosure, a vCPE service based on a VNF forwarding graph can be provided. Through the UI screen provided by the NFV orchestrator 110, the operator of the service provider can drag and drop icons of a desired service among the modules I200 to I290 according to a communication service request, connect the selected icons of the desired service in the form of the VNF forwarding graph, and immediately provide the desired service according to the communication service request to the subscriber. As a result, each subscriber can be provided services by applying necessary appliances to the VNFs in the ISP's cloud infrastructure. Therefore, the subscriber does not need a separate computer room, and there is no need to arrange the equipment separately for the Internet security.

The integrated platform management apparatus and method can provide a future communication service that does not distinguish between wired, mobile, and hyper-connection communication services with a single infrastructure based on cloud computing based virtualization technologies and SDN/NFV technologies. Therefore, the investment cost (i.e., capital expenditure (CAPEX)) for redundant investment in infrastructure (computer, storage, and network) can be reduced. In addition, the operation of the unified single infrastructure can reduce the operation cost (i.e., operating expenses (OPEX)) for redundant infrastructure operations.

The integrated platform management apparatus and method can provide both wired and wireless communication services. Through this, subscriber (e.g., corporate, home, personal) management, traffic monitoring management by type and grade of service, physical hardware system failure management, security management, and integrated billing management can all be performed on the single integrated platform. Therefore, it is made possible to reduce the CAPEX by the integrated operation of the equipment and reduce the carbon emission by the power reduction by applying the virtualized integrated infrastructure. Also, the virtualization technologies can reduce the use of equipment to be applied to data centers, which can reduce the CAPEX and OPEX.

The integrated platform management apparatus and method can enable a forwarding graph to be configured by using icons of application services having appliance mounted on a system in which an infrastructure (computer, storage, and network) is virtualized on a UI screen. This makes it possible to quickly and easily provide tasks such as communication service creation and change according to a business model of the service provider.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An integrated platform management apparatus to which software defined networking (SDN) technologies and network function virtualization (NFV) technologies are applied, the apparatus comprising:
a virtualized infrastructure manager (VIM) controlling and managing virtualized computing, storage, and network resources of a network function virtualization infrastructure (NFVI) and interaction of the resources of the NFVI;
a virtualized network function manager (VNFM) controlling at least one network function and virtualization of the at least one the network function so that a part of the at least one network function and the NFVI is implemented in software; and
a NFV orchestrator displaying appliance functions of a plurality of virtualized network functions (VNFs) in form of icons on a user interface (UI) screen, and provide integrated wired, mobile, and hyper-connection communication services by connecting functions corresponding to icons selected by an operation support system (OSS) or a business support system (BSS) among the icons displayed on the UI screen in form of a forwarding graph.

2. The integrated platform management apparatus according to claim 1, wherein the NFV orchestrator integrally provides the wired, mobile, and hyper-connection communication services in a unified infrastructure according to a service level agreement (SLA) and a policy based on service requirements of a service subscriber.

3. The integrated platform management apparatus according to claim 2, wherein the NFV orchestrator provides a physical hardware infrastructure function, a virtual machine (VM) function, a virtual network function, a networking protocol function, a virtualized infrastructure function, a wired service module, a mobile service module, a service catalogue module, a big-data analysis platform, and a VNF service automatic test tool in form of icons.

4. The integrated platform management apparatus according to claim 3, wherein the VM function includes a master VM template software image function for configuring VMs or virtual containers (VCs) according to a hypervisor or a docker for automatic initial configuration services in physical hardware resources, and performs the automatic initial configuration to create VM instances.

5. The integrated platform management apparatus according to claim 3, wherein the virtual network function divides a physical network apparatus into a plurality of network functions (NFs) to perform virtualization of the physical network apparatus.

6. The integrated platform management apparatus according to claim 3, wherein the virtualized infrastructure function creates VMs or VCs according to a hypervisor or a docker so, as to allow use of virtualized resources.

7. The integrated platform management apparatus according to claim 3, wherein the wired service module applies VNFs to VMs or VC, for a wired communication service, and provides the wired communication service by configuring a forwarding graph in a drag-and-drop manner with service functions represented as cons through at least one virtualized appliance and at least one virtualized tunneling gateway.

8. The integrated platform management apparatus according to claim 3, wherein the mobile service module applies VNFs to VMs or VCs for a mobile communication service, and provides the mobile communication service by configuring a forwarding graph in a drag-and-drop manner for service functions represented as icons through at least one virtualized appliance.

9. The integrated platform management apparatus according to claim 3, wherein the service catalogue module guarantees resources for a network slice according to a type of a mobile communication service.

10. The integrated platform management apparatus according to claim 3, wherein the big-data analysis platform performs a structured big-data analysis or an unstructured big-data analysis based on data collected from Internet-of-Things (IoT) devices of the hyper-connection communication service.

11. The integrated platform management apparatus according to claim 3, wherein the VNF service automatic test tool performs a VIM function test, a VNF creation/modification/expansion/reduction/removal/function test, a VNF network connection test, an interworking test between VIM and SDN controller, a SDN controller test, and a NFVI function test to ensure that the NFVI meets VIM requirements.

12. The integrated platform management apparatus according to claim 1, wherein the NFV orchestrator provides a subscriber and policy management function, a service catalogue and traffic control management function, a VNFM management function, a VIM management function, a SDN integrated control management function, a micro internet data center (IDC) interoperation management function, a security management function, a billing management function, and a statistics management function in form of a pull-down menu on the UI screen.

13. The integrated platform management apparatus according to claim 12, wherein the service catalogue and traffic control management function retrieves information on a service usage status for each subscriber type, each supplementary service type, each day, or each month, and performs a VNF-specific service chaining monitoring, an infrastructure traffic monitoring for VIMS, an infrastructure resource management, a performance management, a service catalogue management, or a service slicing management.

14. The integrated platform management apparatus according to claim 12, wherein the VNFM management function performs a VNF instance lifecycle management, a snivel instance management, a multiple instance management, a VNF instance configuration management, an update or upgrade of VNF instance software, a change of VNF instance, a VNF instance performance information management, a failure information and event management, a VNF instance provisioning and automatic recovery, or addition and deletion of VNF instance.

15. The integrated platform management apparatus according to claim 12, wherein the VIM management function performs a hardware resource management of entire infrastructure, a virtualization management of virtual infrastructures to which a hypervisor or a docker is applied, an infrastructure resource allocation, management of deallocating, increasing and decreasing allocated resources, or infrastructure operation management.

16. The integrated platform management apparatus according to claim 12, wherein the SDN integrated control management function performs control of an Open vSwitch or an OpenFlow switch according to a network data plan, a network equipment setup, a state collection management, an equipment connection management and integrated control management, a Southbound networking, a Northbound application programming interface (API) networking, a micro IDC networking, an NFV orchestration networking, a service catalogue networking, a networking failure information collection, a failure information propagation and failover, a provisioning, a service function chaining (SFC), or interworking with a network management system (NMS).

17. The integrated platform management apparatus according to claim 12, wherein the micro IDC interoperation management function performs monitoring of equipments applied at edge stages, analysis of information collected at subscriber terminals, storing of data collected from IoT devices, or status management, failure management, recovery function, and security management of micro equipments.

18. The integrated platform management apparatus according to claim 12, wherein the security management function performs monitoring of traffic received by a micro IDC, protocol anomaly detection and monitoring, virus detection, webblocker, remote security connections, or storing of traffic information, and performs analysis of traffic big-data, modified packet blocking, time-based policy setting, allowance or denial of instant messaging and point-to-point (P2P) data transfer, storing of billing information for each service type or each subscriber, storing of log information of multiple equipment, or logging and report of simple network management protocol (SNMP) v2/v3 data.

19. The integrated platform management apparatus according to claim 12, wherein the billing management function performs real time charge data record (CDR) generation and billing processing function, billing processing control function by billing rate, billing history inquiry, billing history management, billing history file creation function, billing by service layer, or billing functions for each service type or each subscriber.

20. The integrated platform management apparatus according to claim 12, wherein the statistics management function performs functions of providing information of statistics on subscriber types, statistics per service type, daily/monthly traffic statistics, statistics on virtualized computing server/storage/network resource information, statistics on physical hardware resource information, micro IDC physical hardware resource statistics, micro IDC virtual resource statistics, billing statistics, or failure statistics.
